(19) United States
(12) Patent Application Publication
(10) Pub. No.: US 2004/0187368 A1
(43) Pub. Date: Sep. 30, 2004

(54) Greeting card with gift holder

(76) Inventor: Daniel R. Foster, Liberty, MO (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/759,394

(22) Filed: Jan. 16, 2004

Related U.S. Application Data
(60) Provisional application No. 60/440,893, filed on Jan. 17, 2003.

(51) Int. Cl. G09F 1/00

(52) U.S. Cl. 40/124.06

(57) ABSTRACT

Certain embodiments of the invention provide a greeting card having a holder element on the front surface of the greeting card. The holder element is capable of retaining a prepaid gift card or the like. One such embodiment provides the gift-giver with an opportunity to retain the prepaid gift card to the greeting card without reducing the area on the inner surface for writing a personal message to the recipient.

### CROSS-REFERENCE TO RELATED APPLICATION

This application claims the benefit of the filing date of U.S. Provisional Patent Application Serial No. 60/440,893 filed on Jan. 17, 2003, the entire contents of which are incorporated herein.

### TECHNICAL FIELD

This description relates to greeting cards and, in certain embodiments, to greeting cards adapted to hold a gift item.

### BACKGROUND

People like to commemorate important events in people's lives, such as weddings, anniversaries, and birthdays, and show their appreciation and affection for others by sending gifts and social expression cards, such as greeting cards. Most greeting cards sent today are mass produced cards purchased in retail establishments such as card shops, gift shops, grocery stores and the like. Gifts, of course, may be purchased at any of a number of retail establishments.

It is not always easy to find a mass produced card that expresses the right sentiment. Additionally, there is a desire on the part of most people to personalize their gifts and greeting cards. Most people write a personal greeting in the mass produced cards that they send to others. Recently, there have been introduced card vending machines or kiosks that enable purchasers to create personalized printed social expression cards. Also, there are software packages that enable people to produce cards using personal computers.

In the area of gifts, most people prefer to give a gift that they believe will be meaningful to and appreciated by the recipient. However, a giver may know only generally the wants and needs of a particular recipient. For example, the giver may know that an intended recipient likes music or a particular style of clothing. However, the giver may not know which musical group the recipient likes or whether the recipient would prefer one article of clothing over another. In such instances, the gift certificate from a store that carries goods of the type appreciated by the recipient might be an appropriate gift.

Gift certificates are now available in the form of prepaid gift cards. Conventional prepaid gift cards are debit cards having a magnetic stripe that encodes a monetary credit amount that can be read by appropriate card reader. Such prepaid gift cards are typically similar in size and shape to standard credit cards and may be used, for example, as a gift certificate or a prepaid merchandise credit toward a purchase at a retail establishment, which is typically identified on the gift card.

People giving a prepaid gift card often find it desirable to accompany the prepaid gift card with a traditional greeting card to make the gift a personal touch. The traditional greeting card provides the giver an opportunity to author a personalized sentiment or the like. Because traditional greeting cards are not adapted to hold a prepaid gift card, the greeting card and prepaid gift card are often presented separately.

### SUMMARY

A greeting card may include on its front surface an element adapted to hold a prepaid gift card or the like. In one embodiment, a greeting card comprises a front panel and a rear panel connected at a fold line and a bag element resembling a shopping bag affixed to a forward surface of the front panel and adapted to releasably retain a prepaid gift card.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a front perspective view of a greeting card in accordance with an embodiment of the invention.

FIG. 2 is a front view of the greeting card from FIG. 1.

FIG. 3 is a rear view of the greeting card from FIG. 1.

FIG. 4 is a right side view of the greeting card from FIG. 1.

FIG. 5 is a left side view of the greeting card from FIG. 1.

FIG. 6 is a top view of the greeting card from FIG. 1.

FIG. 7 is a bottom view of the greeting card from FIG. 1.

Like reference symbols in the various drawings indicate like elements.

### DETAILED DESCRIPTION OF ILLUSTRATIVE EMBODIMENTS

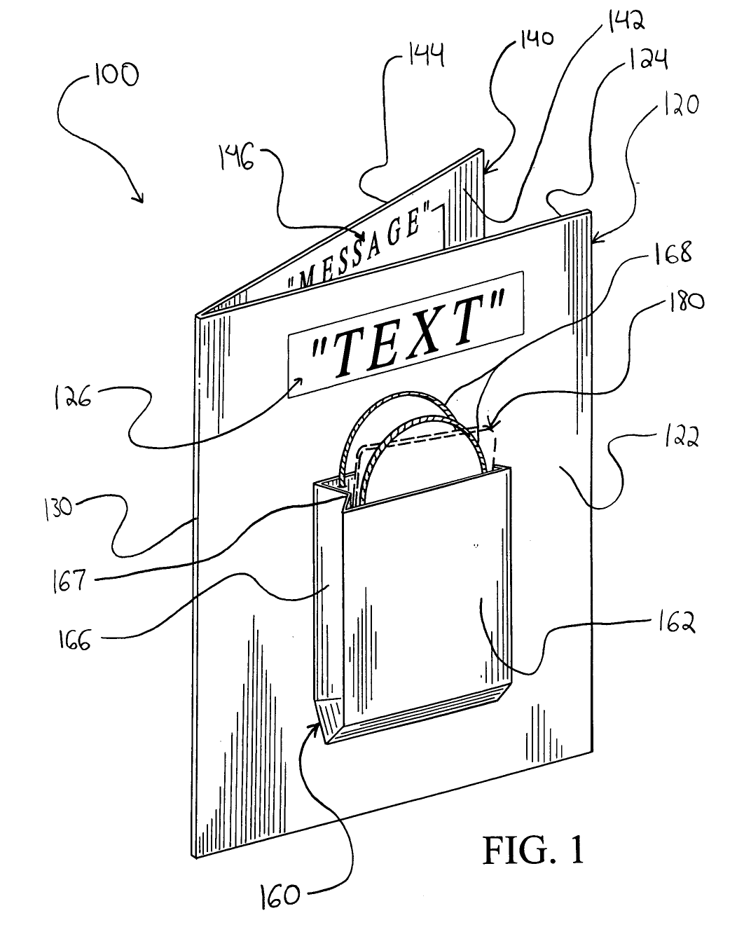

Referring to FIG. 1, a greeting card 100 includes a front panel 120 and a rear panel 140 that are connected at a fold line 130. The front panel 120 includes a front surface 122 and an interior surface 124. Similarly, the rear panel 140 includes a rear surface 142 and an interior surface 144. The panels 120 and 140 are movable about the fold line 130 such that the greeting card 100 may be adjusted between a folded condition and an unfolded condition. When the greeting card 100 is adjusted to a folded condition, as shown for example in FIG. 1, the interior surface 124 of the front panel 120 substantially faces the interior surface 144 of the rear panel 140. When this embodiment of the greeting card 100 is adjusted to an unfolded condition (not shown), the interior surface 124 of the front panel 120 faces in a direction substantially similar to the interior surface 144 of the rear panel 140.

The front and rear panels 120 and 140 can be constructed of any suitable material. For example, the panels 120 and 140 may comprise paper, cardstock, cardboard, plastic, or any combination thereof. Preferably, at least a portion of the front panel 120 or the rear panel 140 is constructed of a material that is suitable for receiving ink or other printing compositions. Various greetings, sentiments, messages, and images may be disposed on the front surface 122, the rear surface, the interior surfaces 124 and 144, or any combination thereof. As shown in FIG. 1, the front surface 122 may include one or more “TEXT” areas 126 that include a label, message, image, or any combination thereof. For example, the “TEXT” area 126 may include a message printed on the front panel 120 such as “HAPPY BIRTHDAY,” “HAPPY ANNIVERSARY,” “CONGRATULATIONS,” or the like. Similarly, at least one of the interior surfaces 124 and 144 may include a “MESSAGE” area 146 that include various greetings, sentiments, messages, and images. For example, the “MESSAGE” area may include a humorous birthday message preprinted on the interior surface 144 of the rear panel 140. Alternatively, one or more of the interior surfaces 124 and 144 may include no preprinted messages, thus providing the gift-giver with a larger area to handwrite a personalize message. The front and rear panels 120 and 140 can be decorated in various colors to provide a pleasant or festive appearance. Images and decorative additions such as ribbons, lace, colored tissue paper, and the like may be included on one or more of the panels 120 and 140.

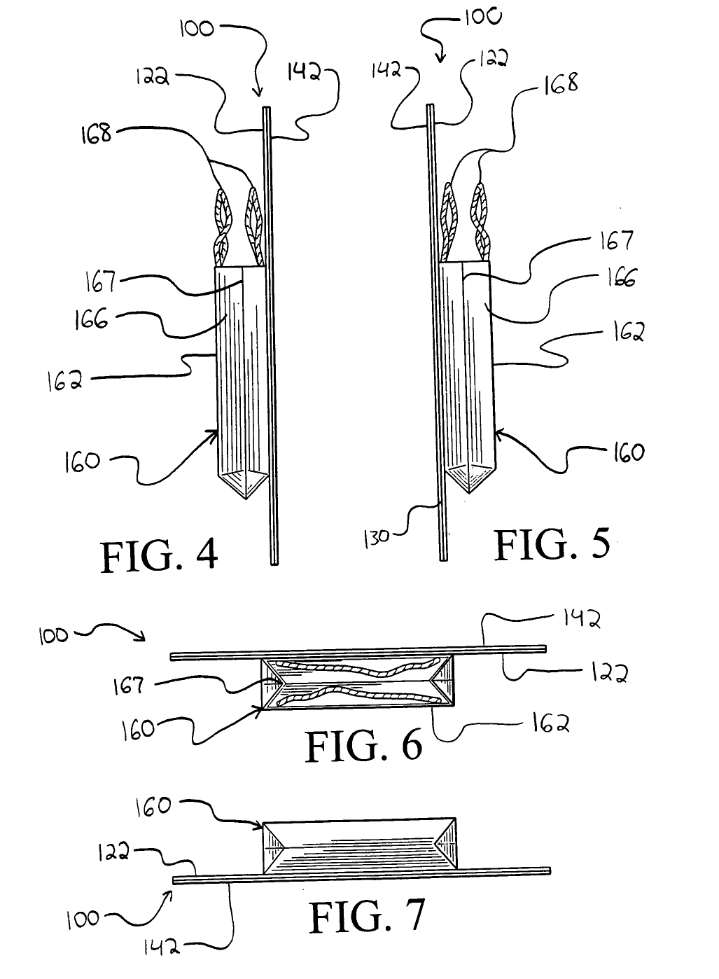

Still referring to FIG. 1, a holding structure 160 is attached to the front surface 122 of the front panel. The holding structure is configured to retain a prepaid gift card 180 or the like in a position that is forward of the front panel 120. As such, the greeting card 100 may be adjusted to a fully folded condition (see, for example, FIG. 4) where the interior surfaces 124 and 144 of the front and rear panels 120 and 140 abut one another without interference from the holding structure 160 or the gift card 180. In addition, the area for printing or writing a message on the interior surfaces 124 and 144 is not limited by the positioning of the gift card 180 or the holding structure 160. For example, a preprinted communication may be printed in the “MESSAGE” area 146 while the complete area on the interior surfaces 124 and 144 is available for the gift-giver to handwrite a personalized message to the recipient. Furthermore, the holding structure 160 and the gift card 180 are prominently positioned on the front side of the greeting card 100 so as to draw the recipient's attention to the holding structure 160 and the gift retained therein. In such an embodiment, the gift card 180 is not necessarily in a secondary position to the front panel 120 of the greeting card 100. Rather, the gift card 180 (which is may have a greater value to the recipient than the greeting card 100) is noticeably positioned forward of the front panel 120 such that the recipient may first receive the primary gift before unfolding the greeting card 100 to view any messages or images that are included on the interior surfaces 124 and 144.

In the embodiment shown in FIG. 1, the holding structure 160 is a collapsible bag structure that is sized to retain a prepaid gift card 180. The bag structure 160 may be adhesively attached to the front surface 122 of the front panel 120 such that at least one surface 162 of the bag structure 160 faces opposite the front panel 120 of the greeting card 100. One or more side sections 166 of the bag structure may include a fold line 167 to facilitate the collapsible motion of the bag structure 160. In addition, the bag structure 160 may include one or more handles 168 so as to provide the appearance of a miniature gift bag or shopping bag. The bag structure 160 may be constructed of paper, cardstock, plastic, or any other suitable material. The handles 168 can be constructed of rope-like material, paper, decorative wire, or the like. The handles 168 may optionally be omitted. The bag structure 160 may have an image or words thereon, contributing to the overall pleasing appearance of the greeting card 100. The shape of the structure 160 may provide a visually appealing appearance and an enjoyable method of delivering a prepaid gift card 180 to a recipient.

Because the structure 160 and the gift card 180 retained therein are prominently positioned for the recipient, the appearance of the holding structure 160 may conveniently incorporated into the theme of the greeting card 100. For example, the holding structure 160 may have the appearance of a miniature shopping bag from the recipient's favorite retail establishment, and a prepaid gift card 180 from that retail establishment may be retained in the bag structure 160. This “shopping” theme may be incorporated into the theme of the greeting card 100 by including the phrase “HAPPY BIRTHDAY . . . LET'S GO SHOPPING!” or the like in the “TEXT” area 126 or the “MESSAGE” area 146 of the greeting card 100. Furthermore, the name or trademark of the retail establishment may be printed on the forward surface 162 of the bag structure 160 and/or the gift card 180 so as to emphasize the “shopping” theme of the gift-giving event.

The holding structure 160 may also include a retention element (not shown in FIG. 1), which operates to releasably retain the gift card 180. For example, the handles 168 of the bag structure 160 may be adapted to be tied, snapped together, or otherwise secured so as to retain the gift card 180 in the bag structure 160. Alternately, the dimensions and pleating in the bag structure 160 may be adapted to frictionally hold the gift card 180 of a predetermined size. Adhesive tape with a release liner or other conventional affixation means may be installed within the bag structure 160 to allow a gift-giver to releasably secure the gift card 180 in the bag structure 160 before presenting the greeting card 100 to the recipient.

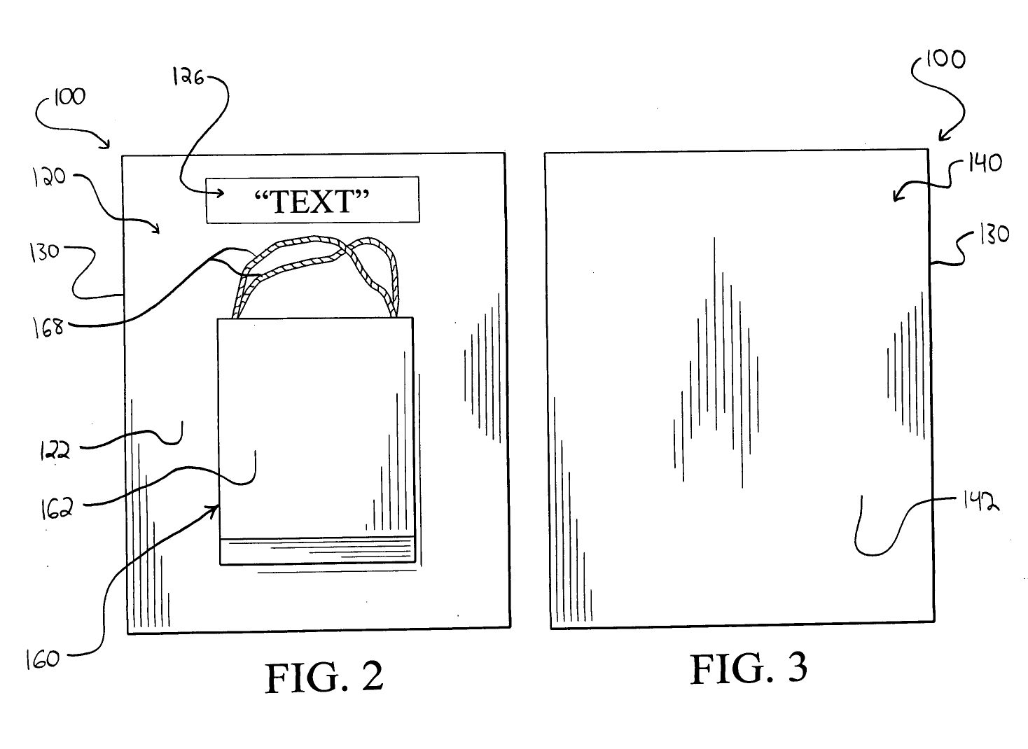

Referring to FIG. 2, the holding structure 160 is sufficiently sized to retain a prepaid gift card 180, but may be smaller than the front panel 120. Although the holding structure 160 is shown in FIG. 2 as being approximately centered on the front panel 120, other embodiments may include a holding structure 160 that is attached to the front panel 120 in an off-centered position.

Referring to FIG. 3, the rear surface 142 of the rear panel 140 may include pricing information, advertising information, trademark information, address information, and a bar code identifying the card. Other images or message may also be printed on the rear surface 142 of the back panel 140.

Referring to FIGS. 4-7, the holding structure 160 is attached to the front panel 120 such that the holding structure 160 and any gift card 180 retained therein is positioned forward of the front panel 120. The holding structure 160 may be attached to the front panel 120 by adhesives or by other attachment means. Alternatively, components of the holding structure 160 may be integrally formed with the front panel 120. As shown in FIGS. 4-7, the greeting card 100 may be adjusted to a fully folded condition. The front and rear panels 120 and 140 may be adjusted to the fully folded condition such that the interior surfaces 124 and 144 abut one another without interference from the holding structure 160 or the gift card 180.

The invention is not limited to the illustrative embodiment shown in FIG. 1. For example, the front and rear panels 120 and 140 shown in FIG. 1 are rectangular in shape, and are substantially the same size. In other embodiments, the panels 120 and 140 may have alternative shapes such as the outline of an animal or cartoon character, and the panels 120 and 140 need not be the same size. Also, front panel 120 may consist of a double layer of material (or a larger panel doubled back on itself and attached thereto) to provide additional rigidity. Fold line 130 need not be a continuous fold line, but instead may be broken by gaps or cutouts into fold line sections in certain embodiments.

Furthermore, any number of folds or panels may be incorporated into the gift card construction. For instance, additional panels or folds may be used to create a tri-panel card construction. In one example, the front and rear panels 120 and 140 may be interconnected with an intermediate panel such that one fold line connects the front panel 120 and the intermediate panel and another fold line connects the rear panel 140 and the intermediate panel.

The greeting card embodiment shown in FIG. 1 may have any orientation. For example, the depicted embodiment is typically referred to as a vertical or portrait orientation. Alternatively, horizontal or landscape orientations may be implemented.

Although the embodiment shown in FIG. 1 is configured to hold a prepaid gift card 180, the holding structure 160 may also hold other gift items, such as monetary currency, banks checks, earrings, a bracelet, a necklace, a ring, or a watch. A personalized note may also be enclosed within the holding structure 160.

Other embodiments of the holding structure 160 may have a construction and appearance other than the collapsible bag structure shown in FIG. 1. For instance, an envelope structure that is configured to retain a prepaid gift card may be attached to the front surface 122 of the front panel 120. The envelope structure may have the appearance of miniature envelope (e.g.,.smaller than the typical letter-sized envelope), including a flap portion that is hingedly connected along a fold line. The flap portion may be adjusted to a sealed position where the contents (e.g., gift card 180) of the envelope structure are retained therein. The envelope structure may be attached to the front panel 120 using adhesive or other attachment means such that the flap portion faces forward of the front panel 120 and may be freely adjusted about the envelope fold line to the sealed position.

In another example, a box structure, rather than the collapsible bag structure, may be attached to the front panel 120 of the greeting card 100. The box structure may be capable of retaining a prepaid gift card 180 and may have the appearance of a miniature gift box that is adorned with colored paper, ribbon, and other decorations. The box structure may include an open top surface that is covered using a lid. The lid may be hingedly attached to or separable from the box structure. The box structure may be attached to the front panel 120 of the greeting card 100 such that the lid is adjustable to uncover the open top surface and reveal the contents therein (e.g., gift card 180). In some embodiments the box structure may be attached to the front panel using adhesive or other attachment means. Alternatively, the box structure may be formed integrally with the front panel so that the box structure is positioned forward of the front surface 122 of the front panel 120.

Further yet, the holding structure 160 may be a sleeve structure attached to the front surface 122 of the front panel 120. The sleeve is capable of retaining a gift card 180 in a position forward of the front panel 120 and may resemble a miniature version of typical 9″×12″ open-ended envelopes. The sleeve may be attached to the front panel using adhesive or other attachment means or may be formed integrally with the front panel.

In another embodiment, the holding structure 160 may be a pocket structure that is attached to the front panel 120 of the greeting card 100. The pocket structure may be formed by affixing a substantially planar piece of any suitable material, such as plastic, paper, or cardstock, to the front surface 122 of the front panel 120. The pocket structure is capable of retaining a gift card 180 therein. For example, the pocket structure may be appropriately sized such that the gift card 180 is friction-fit to the pocket in a position that is forward of the front surface 122.

In addition, the holding structure 160 may be a net-type pocket on the front surface 122 of the panel 120. The net-type structure may be formed using lengths of string, cord, or the like. The net-type structure may be attached to the front surface 122 with adhesive or other attachment means. Alternatively, the net-type pocket structure may be attached to the front panel 120 by weaving the ends of the string through holes or grommets in the front panel 120 and securing the ends on the backside of the front panel 120.

In some embodiments, more than one holding structure 160 may also be used on a single front panel 120, and the multiple holding structures 160 may be configured to hold a gift item cooperatively.

A number of embodiments of the invention have been described. Nevertheless, it will be understood that various modifications may be made without departing from the spirit and scope of the invention.

What is claimed is:

1. A greeting card comprising:
a front panel and a rear panel connected at a fold line, the front panel having a front surface and an interior surface such that the interior surface substantially faces the rear panel when the greeting card is in a folded condition; and
a collapsible bag structure attached to the front surface such that the collapsible bag structure is positioned forward of the front panel,
wherein the collapsible bag structure is operable to releasably retain a prepaid gift card in a position forward of the front panel when the greeting card is in the folded condition.

2. The greeting card of claim 1, wherein the collapsible bag structure has the appearance of a miniature shopping bag from a department store.

3. The greeting card of claim 2, wherein the collapsible bag structure is adapted to retain a prepaid gift card from that department store.

4. The greeting card of claim 1, wherein the collapsible bag structure includes a retention element to releasably retain the prepaid gift card.

5. The greeting card of claim 1, wherein the collapsible bag structure is attached to the front surface of the front panel such that the interior surface of the front panel and an interior surface of the rear panel are completely available to receive a written or printed message.

6. The greeting card of claim 5, wherein the interior surfaces of the front panel and the rear panel are operable abut one another when the greeting is in the folded condition.

7. The greeting card of claim 1, wherein the collapsible bag structure is adhesively attached to the front surface of the front panel.

8. A greeting card comprising:
a front panel and a rear panel, the front panel having a front surface and an interior surface, wherein the greeting card is operable to be adjusted to a folded condition such that the interior surface of the front panel substantially faces the rear panel; and
a means for retaining a gift card, the retaining means being attached to the front surface of the front panel and being positioned forward of the front panel,
wherein the retaining means is operable to releasably retain the gift card in a position forward of the front panel when the greeting card is in the folded condition.

9. The greeting card of claim 8, wherein the retaining means includes a collapsible bag structure affixed to the front surface of the front panel.

10. The greeting card of claim 9, wherein the collapsible bag structure has the appearance of a miniature shopping bag from a department store.

11. The greeting card of claim 10, wherein the collapsible bag structure is adapted to retain a prepaid gift card from that department store.

12. The greeting card of claim 8, wherein the retaining means includes an envelope structure for retaining a prepaid gift card.

13. The greeting card of claim 8, wherein the retaining means includes a miniature gift box that is operable to be opened to reveal a prepaid gift card retained therein.

14. The greeting card of claim 8, wherein the retaining means is attached to the front surface of the front panel such that the interior surface of the front panel and an interior surface of the rear panel are completely available to receive a written or printed message.

15. The greeting card of claim 8, wherein the front panel and rear panel are connected a fold line.

16. The greeting card of claim 15, wherein the interior surface of the front panel is operable abut an interior surface of the rear panel when the greeting is in the folded condition.

17. The greeting card of claim 8, further comprising a third panel that interconnects the front panel and the rear panel, the front panel being connected to the third panel at a first fold line and the rear panel being connected to the third panel at a second fold line.
